(19) United States
(12) Patent Application Publication
(10) Pub. No.: US 2025/0189188 A1
(43) Pub. Date: Jun. 12, 2025

(54) REFRIGERANT FILTRATION APPARATUS AND METHOD

(71) Applicant: Airsept, Inc., Atlanta, GA (US)

(72) Inventors: Aaron Becker, Atlanta, GA (US); Charles B. Abbott, Indianapolis, IN (US); John Hancock, Fishers, IN (US)

(21) Appl. No.: 18/974,591

(22) Filed: Dec. 9, 2024

Related U.S. Application Data
(60) Provisional application No. 63/608,154, filed on Dec. 8, 2023.

(51) Int. Cl. F25B 43/00; B01D 17/00; B01D 29/05

(52) U.S. Cl. CPC F25B 43/003; B01D 17/005; B01D 29/05

(57) ABSTRACT

A device and method for removal of contaminants from refrigerant distributes admitted refrigerant to each of a plurality of reactor collectors, heats each collector to vaporize the refrigerant, whereupon the vaporized refrigerant flows through a filter and then through an outlet. The device includes a housing, a fluid distribution manifold with a plurality of lines, each line directing refrigerant to one of a plurality of collectors, each collector being associated with a line to supply refrigerant, a heating element to heat the collectors and a filter disposed between an outlet and the collectors.

### RELATED APPLICATION

This application is a nonprovisional of and claims the benefit of priority of U.S. Provisional Application 63/608,154 filed Dec. 8, 2023, the entire contents of which are incorporated herein by this reference.

### FIELD OF THE INVENTION

This invention relates generally to refrigerants, and, more particularly, to a method and apparatus to remove contaminants from refrigerants such as R-1234yf.

### BACKGROUND OF THE INVENTION

R-1234yf refrigerants for mobile air-conditioning systems have been widely used in passenger vehicles the past several years, but they are just now gaining traction in medium and heavy-duty commercial vehicles. Environmental policies are driving the shift to R-1234yf, which has a Global Warming Potential (GWP) of <1 compared to R-134a's GWP of 1,300.

A significant difference is due to R-1234yf being a hydrofluoroolefin (HFO), a molecule that has a very short-lived atmospheric life. While hydrofluorocarbon (HFC) R-134a remains in the atmosphere an average of 12 years, R-1234yf's atmospheric lifetime averages a mere 11 days.

As used herein, “contaminants” are substances that are not desired in the refrigerant. Removal of contaminants from refrigerants, such as 1234yf, is essential for longevity of a system. Contaminants may compromise utility of an HVAC system. Contaminants may comprise impurities, products of reactions, and foreign substances introduced into a system. Reactions may occur with materials contacted by the refrigerant in a system, with air or water (liquid or vapor) within a system or delivery source, or with lubricants in a system. Reactions may occur swiftly or progress slowly over time. Reactions include breakdown over time of the refrigerant due to instability. Contaminants may be produced from such reactions.

To reduce risk of contaminants fouling a system, a device for removing the contaminants is needed. Prior mechanical filters are useful, but not particularly effective for R-1234yf. One contaminant in R-1234yf is a stringy plastic or foam-like substance that can quickly impede flow through a mechanical filter.

A device for removing contaminants from R-1234yf is needed. The device should be reliable and easy to use. It should quickly remove contaminants, without appreciably delaying or interfering with filling or refilling of a system. It should be effective for multiple sequential uses without fouling.

The invention is directed to overcoming one or more of the problems and solving one or more of the needs as set forth above.

### SUMMARY OF THE INVENTION

To solve one or more of the problems set forth above, in an exemplary implementation of the invention, a device for removal of contaminants from refrigerant such as R-1234yf includes a vessel with an inlet and an outlet. The vessel contains a distribution system that distributes refrigerant to collectors to facilitate heating. The vessel contains a heating susbsystem for heating admitted potentially contaminated R-1234yf to a vaporization temperature. The vessel also contains a mechanical filtration subsystem through which the vaporized R-1234yf may flow, but most or all foams and solids cannot flow. The vaporized R-1234yf flows through a mechanical filter to the outlet. The outlet may be coupled to supply tank, to a recycling system or to an HVAC system, such as an automotive air conditioning system.

An exemplary method entails admitting the refrigerant into a filter assembly. Upon admission, the refrigerant is distributed to facilitate vaporization, as in step 15. By way of example and not limitation, the admitted refrigerant may be divided into separate reactor collectors (e.g., containers or cups). Each collector is heated thereby heating each separate volume of refrigerant. The refrigerant is heated to vaporization. Upon vaporization, an exhaust port may be opened. The vaporized filter is passed through a filter between the collectors and exhaust port. Filtration prevents passage of any suspended solids and foams from the vaporized refrigerant, before the vaporized filtered refrigerant is exhausted to its destination.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a high-level flow chart for an exemplary refrigerant filtering process according to principles of the invention;

FIG. 2 is front view of an exemplary refrigerant filtering apparatus according to principles of the invention;

FIG. 3 is perspective view of an exemplary refrigerant filtering apparatus according to principles of the invention;

FIG. 4 is section view of an exemplary refrigerant filtering apparatus according to principles of the invention;

FIG. 5 is an exploded view of an exemplary refrigerant filtering apparatus according to principles of the invention;

FIG. 6 is a front view of an exemplary manifold for distributing admitted refrigerant to each of a plurality of containers, cups or compartments for heating to vaporization according to principles of the invention;

FIG. 7 is a perspective section view of an exemplary manifold for distributing admitted refrigerant to each of a plurality of containers, cups or compartments for heating to vaporization according to principles of the invention;

FIG. 8 is a perspective view of an exemplary pressure relief valve for an exemplary refrigerant filtering apparatus according to principles of the invention;

FIG. 9 is a front view of an exemplary heating element for an exemplary refrigerant filtering apparatus according to principles of the invention.

FIG. 10 is a perspective view of an exemplary reactor collector assembly for an exemplary refrigerant filtering apparatus according to principles of the invention; and

FIG. 11 is a plan view of an exemplary filter for an exemplary refrigerant filtering apparatus according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

R1234yf, a refrigerant used in modern automotive air conditioning systems, undergoes a cycle of phase changes and pressure/temperature fluctuations as it circulates through an automotive air conditioning system. The refrigerant enters the compressor as a low-pressure gas. The compressor compresses the gas, significantly increasing its pressure and temperature. The compressed, hot gas flows into the condenser where the gas releases heat to the environment, cooling down and condensing into a high-pressure liquid. The high-pressure liquid passes through a restriction device, such as an expansion valve or orifice tube. A sudden drop in pressure causes the liquid to flash-vaporize into a low-pressure mixture of liquid and gas. The low-pressure mixture enters the evaporator, which is located inside the vehicle's cabin. As the refrigerant absorbs heat from the cabin air, it vaporizes completely into a low-pressure gas. The expansion valve/orifice tube and evaporator are crucial for creating the cooling effect by causing the refrigerant to vaporize and absorb heat. This cooling effect is what cools the air that is blown into the cabin. The low-pressure gas is then drawn back into the compressor, starting the cycle again. The refrigerant changes phases multiple times during the cycle: from gas to liquid and back to gas. This continuous cycle allows the automotive air conditioning system to efficiently cool the cabin by transferring heat from the inside to the outside of the vehicle.

The pressure and temperature of the refrigerant fluctuate significantly throughout the cycle. Low side pressures may vary considerably, according to ambient temperature, from a low of about 20 psi to a high of about 60 psi. High side pressures may vary considerably, according to ambient temperature, from a low of about 120 psi to a high of about 300 psi. These values are approximate, for illustrative purposes, and can vary depending on the specific vehicle and system.

Over time, components of an air conditioning system fail. During service, refrigerant is recovered and recycled from the system. The process typically involves recovering the refrigerant, filtering out contaminants, and then recharging the system with fresh and/or recycled refrigerant. This ensures the system runs smoothly and efficiently while adhering to environmental and safety standards.

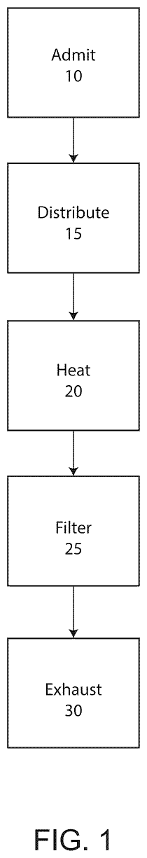

FIG. 1 is a high-level flow chart for an exemplary refrigerant filtering process according to principles of the invention. A method according to principles of the invention includes admitting the refrigerant into a filter assembly, as in step 10. Admission may be accomplished by evacuating a filter container using a vacuum pump. After evacuation, a supply of refrigerant is fluidly coupled to the container. A pressure differential created by the evacuation causes refrigerant to flow from the supply into the compartment. The evacuation ensures that the compartment is substantially devoid of gasses, other than those associated with the admitted refrigerant.

Upon admission, the refrigerant is distributed to facilitate vaporization, as in step 15. By way of example and not limitation, the admitted refrigerant may be divided into separate reactor collectors (e.g., containers or cups). Division may be accomplished by passing the admitted refrigerant through a manifold with an outlet fluidly coupled to each collector. Division separates the refrigerant into separate volumes, each volume being less than the total volume admitted and facilitating heating to vaporization. The separate volumes may be equal or not equal. The separate volumes are more quickly heated to a vaporization temperature. By dividing the refrigerant into smaller, discrete volumes within individual collectors, the surface area available for heat transfer increases. This design allows the refrigerant to reach its vaporization temperature more quickly and uniformly compared to heating the refrigerant as a single bulk volume. The collectors are designed with a combined capacity exceeding the refrigerant volume (e.g., 150%-250% of the admitted refrigerant volume). This ensures that no single collector overflows, which is vital for maintaining operational safety and efficiency.

As in step 20, each collector is heated thereby heating each separate volume of refrigerant. The refrigerant is heated to vaporization. By way of example, a heating element in contact with or in close proximity to the collectors may generate sufficient heat to cause the contained volumes of refrigerant to vaporize.

Heating a volume of liquid R1234yf to its vaporization temperature involves distinct phases. As heat is added to the liquid R1234yf, its temperature increases. This phase is known as sensible heating because the added energy is directly proportional to the temperature rise. The amount of energy required for this phase depends on the specific heat capacity of the liquid, its mass, and the desired temperature increase. The energy (Q) required can be calculated using the formula:

Q=mcΔT

Where:
m is the mass of the liquid (kg)
c is the specific heat capacity of the liquid (J/kg·K)
ΔT is the temperature change (K)

Once the liquid R1234yf reaches its boiling point, further addition of heat does not

increase its temperature but instead causes it to change its phase from liquid to gas. This energy is known as the latent heat of vaporization. The amount of energy required for this phase depends on the mass of the liquid and its latent heat of vaporization. The energy (Q) required can be calculated using the formula:

Q=mLv

Where:
m is the mass of the liquid (kg)
Lv is the latent heat of vaporization of the liquid (J/kg). The latent heat of vaporization of R1234yf(2,3,3,3-Tetrafluoroprop-1-ene) is approximately 200 kJ/kg. This value can vary slightly depending on the specific conditions, such as temperature and pressure.

Upon vaporization, an exhaust port may be opened. A destination for the filtered refrigerant may be coupled to an outlet. The destination may be evacuated to provide a flow-inducing pressure differential. Alternatively, a pump may be used to create a flow-inducing pressure differential. The vaporized refrigerant passes through a filter, as in step 25, that prevents passage of suspended solids and foams from the vaporized refrigerant, before the vaporized filtered refrigerant is exhausted through an outlet, as in step 30.

As the refrigerant vaporizes, contaminants, including the problematic stringy solids or foam substances, are left behind within the collectors. Testing of such a device using such a method shows appreciable residue in the form of a stringy flexible solid or foam substance remaining in device, filtered from the exhausted refrigerant. It is believed that the residue is a contaminant that would compromise utility of an HVAC system if it was not removed from the refrigerant prior to the refrigerant's introduction into the HVAC system. Containment simplifies subsequent cleaning and reduces the risk of contaminants spreading into downstream components.

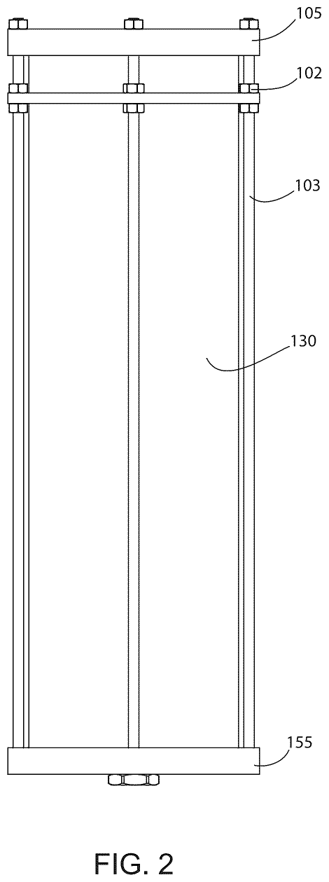

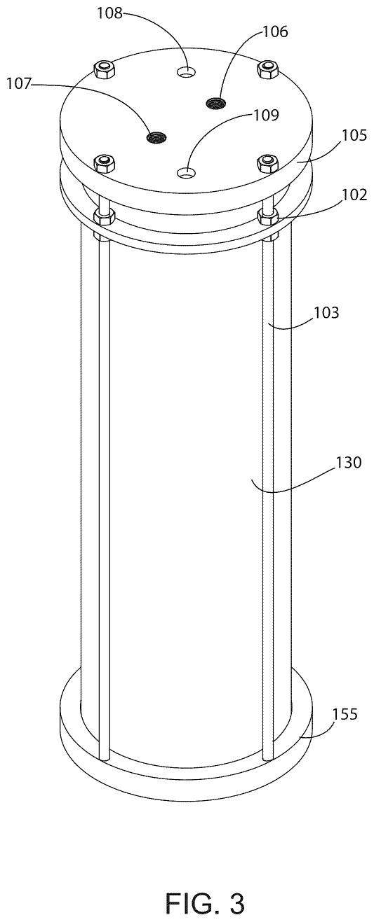

Referring now to FIGS. 2 and 3, the exterior of an exemplary device for filtering refrigerant according to the method described above is conceptually illustrated. The invention provides an exemplary device for removal of contaminants from refrigerant such as R-1234yf. The device includes a housing. The housing contains fluid distribution, fluid collection, heating and filtering components. Ports to the housing allow connection to a vacuum pump, connection to a refrigerant supply and connection to a filtered refrigerant destination, such as a tank of a recovery machine, an AC system, or a storage tank. The housing accommodates internal components and connections to external systems. It features ports for vacuum pump connection, refrigerant supply, and filtered refrigerant output. The housing may be made of durable materials such as stainless steel or aluminum to withstand pressure and temperature variations.

The exemplary device includes a housing 130 that contains internal components. In the exemplary embodiment, the housing 130 is tubular, with top and bottom covers 105, 155. The top cover 105 includes various ports 107-109. Gaskets, O-rings 115, 150 and other seals may be used to ensure a fluid-tight seal between each cover 105, 155 and the housing 130. In the exemplary embodiment the covers 105, 155 are mechanically secured to the body with threaded rods 103 and nuts 105. However, the invention is not limited to a particular means of achieving a fluid-tight seal between the covers 105, 155 and the housing 130. Other mechanical attachments may be used to secure the covers 105, 155 to the body within the spirit and scope of the invention.

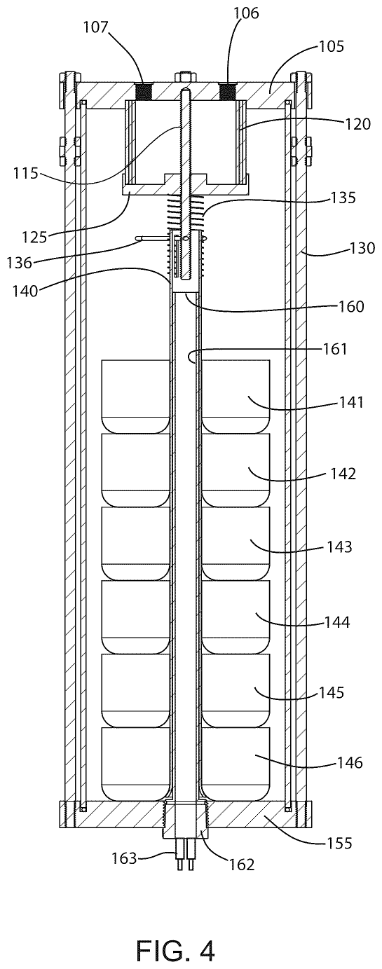

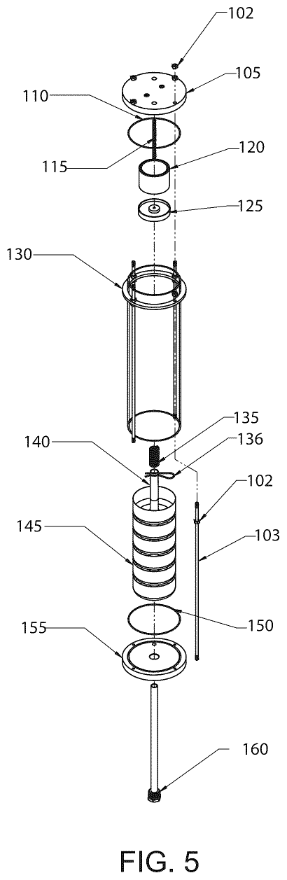

FIGS. 4 and 5 conceptually illustrate internal components of the device. The components include a filter 120, through which refrigerant must pass before flowing through an outlet. The components also include a reactor assembly, which includes a plurality of collectors 141-146, in a stacked arrangement, on a tube 140. Each collector 141-146 is a cup-shaped receptacle with a central tube, as in the style of a bundt or tube pans. The number and combined volume of collectors 141-146 are selected to contain the entire volume of admitted refrigerant, without overflowing any collector 141-146. In a preferred implementation, the collectors 141-146 provide a total storage volume that substantially exceeds the volume of admitted refrigerant, such as a combined storage volume of 150% to 250% the volume of admitted refrigerant. The collectors 141-146 are thermally conductive to facilitate heating. A nonlimiting example of a suitable material is an aluminum alloy.

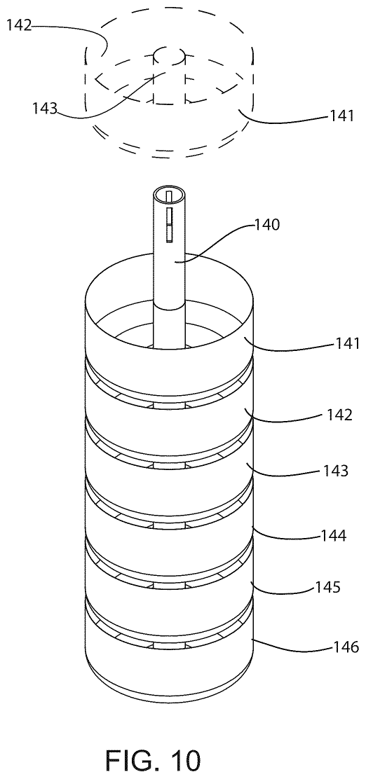

The collectors 141-146 are arranged in a stack, as also shown in FIG. 10. Although it may be difficult to discern from the drawings, a space is provided between adjacent stacked collectors 141-146 to allow vaporized refrigerant to escape.

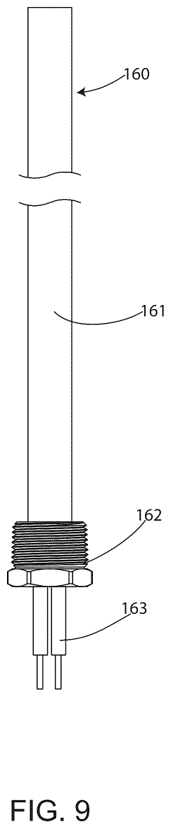

The tube 140 provides a structure onto which the collectors 141-146 are arranged. Additionally, the tube 140 receives a heating element 160, such as the element 160 conceptually illustrated in FIG. 9. The heating element may include a threaded (e.g., NPT ¾″) connection 162, which threadedly engages a port in the bottom cover 155. The element may include a pipe 161 (e.g., a stainless-steel pipe that contains an electric heating element. Electrodes 163 extend from the contained heating element through the threaded connection. Supplying an electric current at a voltage required by the heating element 160 causes the electric heating element to heat up, which causes the tube 161 to heat. The heated tube 161 causes the collector tube 140 to heat up, which causes the collectors 141-146 to heat, which causes the refrigerant contained in the collectors 141-146 to heat.

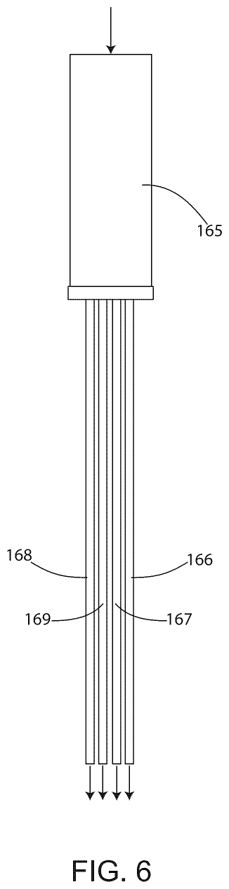

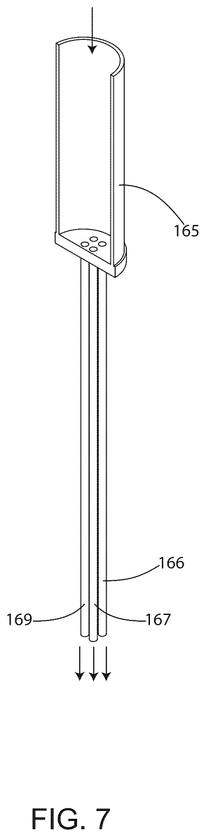

Each collector 141-146 may be supplied refrigerant from an inlet port, through a manifold, to a capillary tube that extends to the collector 141-146. An exemplary manifold is conceptually illustrated in FIGS. 6 and 7. An inlet portion 165 of the manifold is fluidly coupled to an inlet port (e.g., port 106) in the cover 105. A plurality of narrow tubes, e.g., capillary tubes, 167-169 are fluidly coupled to the inlet portion 165. While four capillary tubes are shown in the view of FIG. 6, there may be additional tubes behind those shown in the Figure. Preferably, there are enough capillary tubes to deliver refrigerant to each collector. Concomitantly, preferably there are no more than enough capillary tubes to deliver refrigerant to each collector. The manifold distributes the admitted refrigerant. The manifold divides the admitted refrigerant into volumes that flow through each capillary tube. In generally, the sum of the divided volumes equals the volume of the admitted refrigerant. Each capillary tube 167-169 may be cut to size to reach a collector. The capillary tubes may be bent (preferably without kinking) and directed to reach the collectors 141-146. Illustratively, a capillary tube cut to size to reach collector 141 may have a different length than a capillary tube cut to size to reach collector 146. A malleable capillary tube, such as a copper tube, will retain its bent shape.

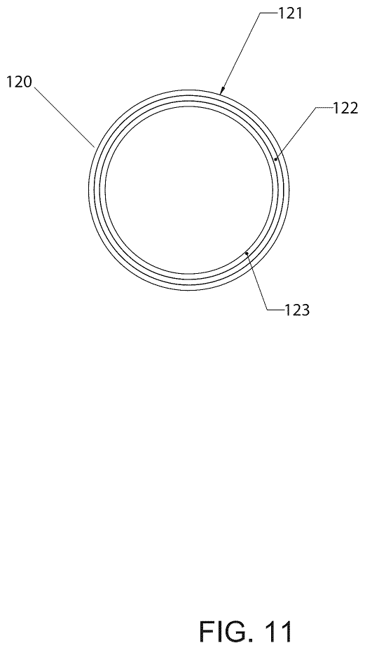

A filter 120 is supported by a filter retainer 125 with a threaded rod 115 connected to the underside of cover 105. An exemplary filter 120, as conceptually illustrated in FIG. 11, may include filter paper 122 disposed between inner and outer wire meshes 121, 123.

A compression spring 135 is disposed between a hitch pin 136 attached to tube 140 and the bottom of the filter retainer 125. The compression spring 136 urges the tube 140 against the bottom cover 155. Mechanical means, other than the spring 135 and pin 136, may be used for securing the tube 140 and collectors 141-146 in place within the spirit and scope of the invention.

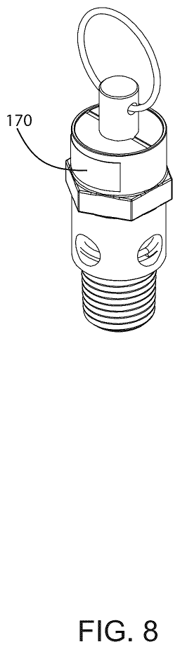

One of the ports (e.g., port 108) may be configured to receive a pressure relief valve, such as the pressure relief valve conceptually illustrated in FIG. 8. The valve 170 maintains a fluid tight seal until the valve is manually opened, such as by pulling the ring, or the pressure inside the housing 130 exceeds a threshold (e.g., exceeds 200 psi). The port 108 may be threaded to mate with threads (e.g., ⅛″ or ¼″ NPT) on the valve 170. If the outlet is blocked and the pressure within the housing 130 exceeds the threshold, the pressure relief valve will open. When the pressure is relieved to a pressure that is below the threshold, the pressure relief valve 170 will close. Some refrigerants, including R-1234yf, are flammable under certain conditions. While R-1234yf should not ignite during normal operation of the device, a malfunction may cause ignition. In such case, the pressure relief valve 170 may help avoid a destructive failure of the device (e.g., an explosion).

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A device for removal of contaminants from refrigerant comprising
a housing assembly including an inlet port and outlet port;
a reactor assembly contained in the housing assembly, the reactor assembly comprising a vertical tube, and a plurality of collectors in a spaced apart concentric arrangement, the vertical tube extending through the center of each collector, and a heating element within the vertical tube;
a fluid delivery assembly fluidly coupling each collector to the inlet port of the housing; and
a filter assembly fluidly coupled to the outlet port of the housing.

2. The device for removal of contaminants from refrigerant of claim 1, wherein each collector comprises a cup for containing a liquid.

3. The device for removal of contaminants from refrigerant of claim 1, wherein each collector and the vertical tube are thermally conductive.

4. The device for removal of contaminants from refrigerant of claim 1, wherein each collector provides a volume for fluid storage, and the sum of all such volumes for all collectors of the plurality of collectors is at least equal to a volume of refrigerant admitted through the inlet port.

5. The device for removal of contaminants from refrigerant of claim 1, wherein the heating element has a length that does not exceed a length of the vertical tube.

6. The device for removal of contaminants from refrigerant of claim 1, wherein the heating element is configured to supply sufficient heat to vaporize liquid refrigerant in each collector.

7. The device for removal of contaminants from refrigerant of claim 6, wherein the liquid refrigerant comprises R-1234yf.

8. The device for removal of contaminants from refrigerant of claim 7, wherein the heating element is configured to supply sufficient heat to vaporize the refrigerant in each collector within 5 minutes.

9. The device for removal of contaminants from refrigerant of claim 7, wherein the heating element is configured to supply sufficient heat to vaporize the refrigerant in each collector within 1 minute.

10. The device for removal of contaminants from refrigerant of claim 7, wherein the heating element is configured to supply sufficient heat to vaporize the refrigerant in each collector within 30 seconds.

11. The device for removal of contaminants from refrigerant of claim 1, the fluid delivery assembly comprising a manifold having an inlet fluidly coupled to the inlet port of the housing, and a plurality of outlets, each of outlet of the plurality of outlets being fluidly coupled to a collector.

12. The device for removal of contaminants from refrigerant of claim 11, the fluid delivery assembly further comprising a capillary tube extending from each collector to an outlet of the manifold, and each capillary tube extending to different outlet than an outlet to which each other capillary tube extends.

13. The device for removal of contaminants from refrigerant of claim 1, the filter assembly containing at least one mechanical filter element.

14. The device for removal of contaminants from refrigerant of claim 13, the filter assembly being removable from the housing.

15. The device for removal of contaminants from refrigerant of claim 13, the at least one mechanical filter element including filter paper and a wire screen.

16. The device for removal of contaminants from refrigerant of claim 15, each mechanical filter element of the at least one mechanical filter element being removable from the filter assembly.

17. The device for removal of contaminants from refrigerant of claim 1, the reactor assembly being removable from the housing.

18. The device for removal of contaminants from refrigerant of claim 17, each collector being removable from the reactor assembly.

19. The device for removal of contaminants from refrigerant of claim 1, the plurality of collectors including at least 3 collectors.

20. The device for removal of contaminants from refrigerant of claim 1, the plurality of collectors including at least 6 collectors.
